(19) United States
(12) Patent Application Publication
(10) Pub. No.: US 2025/0274393 A1
(43) Pub. Date: Aug. 28, 2025

(54) RESOURCE SHARING AMONG NETWORK GATEWAYS IN SOFTWARE-DEFINED NETWORKS

(71) Applicant: Nokia Solutions and Networks Oy, Espoo (FI)

(72) Inventor: Shailesh Prabhu, Manipal (IN)

(73) Assignee: Nokia Solutions and Networks Oy, Espoo (FI)

(21) Appl. No.: 18/584,085

(22) Filed: Feb. 22, 2024

(51) Int. Cl. H04L 47/122; H04L 47/762

(52) U.S. Cl. CPC H04L 47/122; H04L 47/762

(57) ABSTRACT

The access network (AN) resource manager for a software-defined network (SDN) generates and thresholds congestion scores for the SDN's network gateway (NGs) using a weighted sum of network metrics to identify congested NGs and re-allocate network resources to address the detected congestion. Different weight values for the weighted sums and/or different threshold values for the congestion scores may be used for different AN use cases. Congestion scores may be generated and thresholded at the gateway level or at the gateway-port level. Existing network resources are allocated and possibly de-allocated to automatically and efficiently address congestion issues without having to provision new network resources.

### BACKGROUND

### Field of the Disclosure

The present disclosure relates to software-defined networks and, more specifically but not exclusively, to techniques for reducing congestion in software-defined networks.

### Description of the Related Art

This section introduces aspects that may help facilitate a better understanding of the disclosure. Accordingly, the statements of this section are to be read in this light and are not to be understood as admissions about what is prior art or what is not prior art.

In a conventional software-defined network (SDN), users use their user equipment (UE) to access various internet services, such as audio or video streaming, via different SDN network gateways (NGs). With the advent of 5G, user density is significantly increased. Above 80% of the internet traffic today is video and that percentage is expected to increase in 5G networks due to the commensurate increase in user density. Due to the dynamic nature of networks, service resource provisioning to and/or allocation in an SDN access network becomes challenging due to various factors like varied network congestions, user mobility/handovers, etc.

As used herein, the term “provisioning” refers to the addition of a new resource to an SDN, while the term “allocation” refers to the assignment an existing resource in an SDN. As such, the term “re-allocation” refers to the de-assignment of an existing resource from one NG in an SDN and the corresponding assignment of that same existing resource to another NG in the SDN.

U.S. Pat. No. 9,769,536B2, the teachings of which are incorporated herein by reference in their entirety, addresses congestion issues by re-routing user traffic from highly congested NGs to less-congested NGs.

### SUMMARY

The existing support for application-aware routing eases SDN network congestion by routing the packets via less-congested paths. However, for a given network gateway, if the SDN access network is congested, dynamic provisioning and/or allocation of adequate network resources for last-mile network gateways remains a challenge in today's systems and methods. This is primarily because of unpredictable resource consumption at the access side of network gateways. In a network like 5G and beyond, network automation becomes a key enabler of zero-touch management. As part of network automation in 5G, there is a critical need for techniques to dynamically allocate network resources to last-mile network gateways in order to intelligently service its SDN access network.

Problems in the prior art are addressed in accordance with the principles of the present disclosure by a centralized system to manage network resources of SDN network gateways in the data layer. The system detects network congestion by deriving congestion scores for different NG ports as a result of analysis of various network metrics and a novel weighted-sum approach. The system estimates and shares resources among redundant network gateways having inter-gateway shunt links. The system generates quality of service (QOS) requirements for the smooth functioning of network gateways and their corresponding SDN access networks, based on congestion scores and network resource parameters. The system may re-allocate network resources to congested network gateways by sharing network resources from de-congested network gateways. The system may also re-allocate network resources from a de-congested NG port to a congested NG port within the same NG.

In at least one embodiment of the present disclosure, an apparatus comprise at least one processor and at least one memory storing instructions that, upon being executed by the at least one processor, cause the apparatus at least to receive different network metrics from a first network gateway (NG) of a software-defined network (SDN); generate a first congestion score based on a weighted sum of the network metrics; and, if the apparatus determines that the first congestion score exceeds a first threshold value, then allocate one or more additional network resources for the first NG.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a software-defined network (SDN) according to certain embodiments of the present disclosure;

FIG. 2 is a block diagram of a portion of the SDN of FIG. 1;

FIG. 3 is a flow diagram of some of the processing performed by the AN resource manager of FIG. 1 to handle congestion at network gateways; and

FIG. 4 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

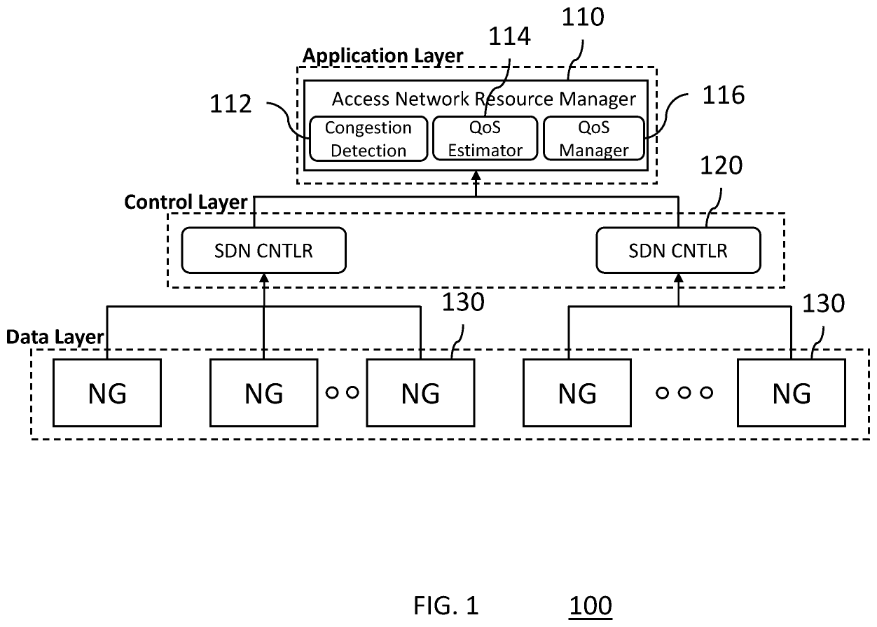

FIG. 1 is a block diagram of a software-defined network (SDN) 100 according to certain embodiments of the present disclosure. As shown in FIG. 1, the SDN 100 has an access network (AN) resource manager 110 that handles (i.e., controls and/or performs) the application-layer operations of the SDN 100, a number of SDN controllers (SDNCs) 120 that handle the control-layer operations of the SDN 100, and a number of network gateways (NGs) 130 that handle the data-layer operations of the SDN 100, where each SDNC 120 handles a different subset of the NGs 130. Those skilled in the art will understand that SDN 100 may have any suitable number of SDNCs 120, with each SDNC 120 independently handling any suitable number of NGs 130.

The NGs 130 are the last-mile access gateways to which the users logically connect to access various services offered by the SDN 100. The SDNCs 120 are the centralized authorities that manage, control, provision, and allocate the data plane with application-layer services. The AN resource manager 110 is responsible for the overall detection of congestion levels in the NG's access networks and overcoming the same.

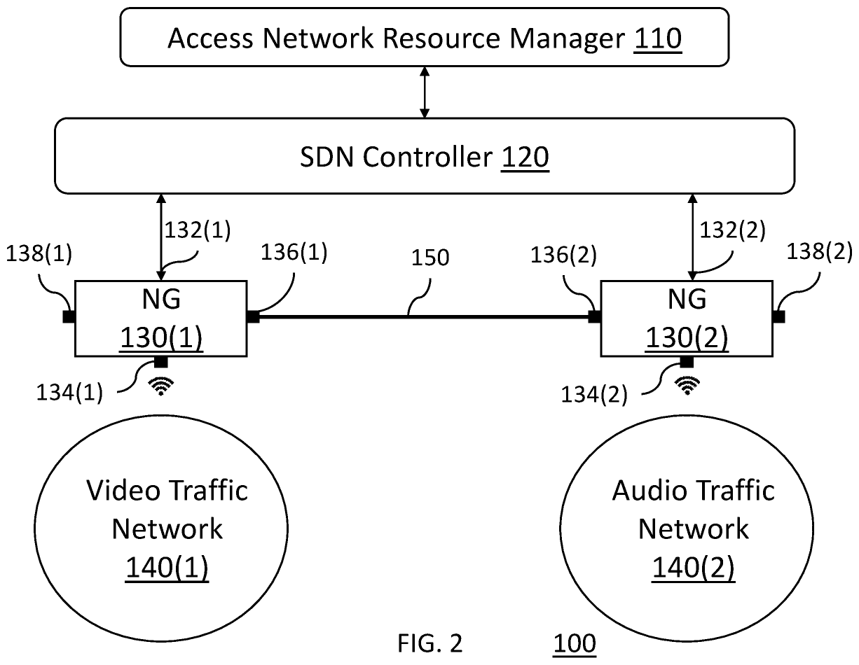

FIG. 2 is a block diagram of a portion of the SDN 100 of FIG. 1 that includes two network gateways 130(1) and 130(2) controlled by the same SDN controller 120. As shown in FIG. 2, network gateway 130(1) has four ports:
Control port 132(1) via which the SDN controller 120 communicates with gateway 130(1) to control gateway operations;
Access port 134(1) via which user packets, e.g., data packets, flow between gateway 130(1) and user equipment (UE) (not explicitly shown in the figures) of users of the SDN 100;
Gateway port 136(1) via which user packets can flow between gateway 130(1) and its associated gateway 130(2) via shunt link 150, which interconnects the two gateways 130(1) and 130(2); and
Network port 138(1) via which user packets flow between gateway 130(1) and an external network (not shown in the figures), such as the Internet.

Network gateway 130(2) has an analogous set of four ports 132(2)-138(2).

In normal operations, upstream (i.e., from a UE to the external network) user packets flow from a UE to an NG 130 via the gateway's access port 134. From there, the upstream user packets may flow from the NG 130 through the gateway's network port 138 to the external network. Analogously, downstream (i.e., from the external network to a UE) user packets flow from the external network to an NG 130 via the gateway's network port 138. From there, the downstream user packets may flow from the NG 130 through the gateway's access port 134 to the appropriate UE.

In the particular situation depicted in FIG. 2, NG 130(1) handles wireless, downstream and/or upstream video traffic 140(1) at its access port 134(1), while NG 130(2) handles wireless, downstream and/or upstream audio traffic 140(2) at its access port 134(2). According to one possible scenario, at some point in time, NG 130(1) is not able—or it is no longer desirable for NG 130(1)—to handle some or all of its video traffic 140(1). For example, a path-computation element/controller in the SDN 100 might compute a more-optimal path for the video traffic 140(1) of NG 130(1). Or the amount of downstream video traffic received at the gateway's network port 138(1) from the external network may become too much for NG 130(1) to handle in a satisfactory manner (e.g., in a manner that provides sufficient quality of service as reflected in such characteristics as bandwidth, latency, jitter, error rate, etc.). Similarly, the amount of upstream video traffic received at the gateway's access port 134(1) from the UEs may become too much for NG 130(1) to handle in a satisfactory manner. It may also be possible for the gateway's network port 138(1) to fail, in which case, no downstream video traffic will be able to be received by NG 130(1) from the external network via the gateway's network port 138(1) and likewise no upstream video traffic will be able to be transmitted by NG 130(1) to the external network via the gateway's network port 138(1). Or one or more UEs associated with at least some of the video traffic 140(1) may physically move closer to NG 130(2) than to NG 130(1).

According to certain embodiments of the disclosure, in any of those situations (and possibly others), some or all of the affected video traffic 140(1) may be transmitted from NG 130(1) via the gateway's gateway port 136(1) over the shunt link 150 to NG 130(2) via that gateway's gateway port 136(2). According to those embodiments, appropriate, additional network resources are allocated to NG 130(2) to handle both the shunted video traffic 140(1) and its own audio traffic 140(2). If necessary, some or all of those additional network resources may be de-allocated from one or more other network gateways 130, possibly including, but not limited to, NG 130(1), where each of those other network gateways 130 may individually and independently be controlled by the same or a different SDN controller 120 as the SDNC that controls NG 130(1) and NG 130(2).

As described further below, in certain embodiments, this allocation and de-allocation of network resources is automatically orchestrated by the SDN's AN resource manager 110. In this way, such embodiments are able to handle congestion issues at the network gateways 130 by automatically re-allocating network resources as needed.

Referring again to FIG. 1, the AN resource manager 110 has a congestion detection block 112, a QoS estimator 114, and a QoS manager 116, where:
The congestion detection block 112 periodically collects a set of network metrics from the NGs 130, derives “congestion scores” based on these metrics, thresholds those congestion scores, and informs the QoS estimator 114 of the existence of congested NGs 130 (i.e., gateways whose congestion scores exceed their assigned congestion-score threshold values);
The QoS estimator 114 estimates the network resource QoS requirements of a congested NG's access network and communicates the same to the QoS manager 116; and
The QoS manager 116 allocates additional network resources to congested NGs 130 based on their QoS requirements as defined by the QoS estimator 114 and, if necessary and appropriate, de-allocates network resources from non-congested NGs 130 whose congestion scores do not exceed their assigned threshold values.

This disclosure proposes a novel weighted-sum technique to detect network congestion at the NGs 130 by the congestion detection block 112. In the weighted-sum technique, each network metric corresponding to an NG 130 collected by the congestion detection block 112 is assigned a weight value, and the congestion score (CS) for that NG 130 is generated based on a weighted sum of the network metrics. In one possible implementation, the congestion score CS is generated by the congestion detection block 112 using the following equation:

CS=w1·UD+w2·BR+w3·L+w4·J+w5·BW,

where:
UD is user density, i.e., the number of users connected with/served by an NG 130;
BR is overall application bit rate of an NG 130;
L is average latency faced in the network corresponding to an NG 130;
J is average jitter faced in the network corresponding to an NG 130;
BW is available bandwidth in the NG 130; and
w1-w5 are five specified weight values for the five network metrics.

Since different network metrics have different units and different ranges of values, the network metrics in the above equation have been normalized to unitless values, e.g., between 0 and 1. Those skill in the art will understand that, in alternative embodiments, the congestion score may be based on a subset of those five network metrics and/or one or more additional network metrics.

The weight value applied to each network metric may depend on the use case served by the NG 130. For example, higher bandwidth is required for video-streaming use cases but not so much for V2X (vehicle-to-everything)-communication use cases. Hence, the bandwidth metric (BW) will be assigned a higher weight value (w5) for video use cases compared to V2X use cases. Similarly, latency (L) becomes critical for both video and V2X use cases. Accordingly, the weight value (w3) will be set relatively high for the latency metric for these use cases compared to other use cases where latency is not as critical. The weight values, which can be based on any suitable ranges, such as numbers between 0 and 10, are pre-configured (and re-configurable) by the network administrator of the SDN 100 based on the serving use cases.

The weight values corresponding to individual parameters (like latency, bandwidth, user density, etc.) depend on the serving end use case. Hence, for each use case that is served, a pre-determined set of weights are stored. For example, in a V2X use case being served by NGs, the below weights are used:
Critical weight value w3 for latency L: In a V2X use case, an ultra-low reliable latency is critical. Hence, in a normalized range between 0 and 1, the weight value w3 may be set at or near 1;
Major weight value w1 for user density UD: In a V2X use case, the number of end users (e.g., vehicles) is important, and hence is categorized as a ‘Major’ weight carrying parameter. Hence, the weight value w1 may be set at or near 0.75;
Minor weight value w5 for bandwidth BW: In a V2X use case, bandwidth is comparatively a less-significant parameter. Hence, the weight value w5 may be set at or near 0.5.

In this way, for a particular use case, there is a pre-determined categorization of weight values as either CRITICAL (e.g., at or near 1), MAJOR (e.g., at or near 0.75), MINOR (e.g., at or near 0.5), or TRIVIAL (e.g., at or near 0). Each of these categories has a specified weight value, but the weight values may be re-configured by the network administrator.

In a video streaming use case, the weight values may be:
Critical weight value w5 for bandwidth BW: at or near 1
Minor weight value w3 for latency L: at or near 0.5
Major weight value w1 for user density UD: at or near 0.75
Major weight value w2 for bit rate BR: at or near 0.75
Minor weight value w4 for jitter J: at or near 0.5

The AN resource manager 110 of FIG. 1 stores different sets of weight values for the different serving use cases and accordingly applies the appropriate weight values when calculating congestion scores for the different serving use cases.

In a possible scenario described above in FIG. 2, after shunting all of NG 130(1)'s video traffic to NG 130(2), the user density (UD) network metric for NG 130(2) will now be the sum of the user densities for both video network 140(1) and audio network 140(2). Likewise, the overall application bit rate (BR) network metric will now be the sum of the video application bit rate and the audio application bit rate. Similarly, the bandwidth (BW) network metric and other network metrics will also vary accordingly. As a result, the new congestion score (CS) for NG 130(2) generated by the congestion detection block 112 may exceed the threshold value assigned to NG 130(2) indicating that now-congested NG 130(2) may need additional network resources to provide sufficient QoS to its current set of users.

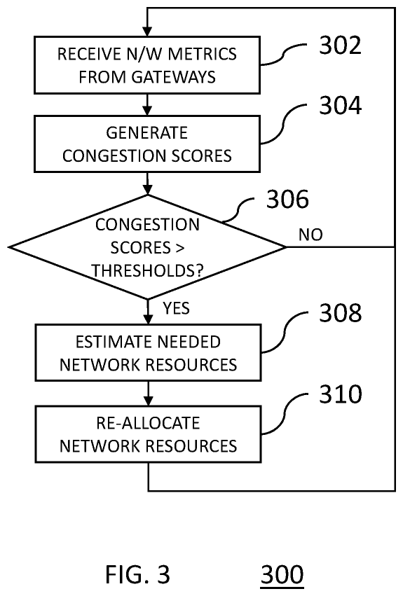

FIG. 3 is a flow diagram of some of the processing 300 performed by the AN resource manager 110 to handle congestion at network gateways 130, according to certain embodiments of the disclosure.

In step 302, the congestion detection block 112 receives network metrics from the NGs 130. In step 304, the congestion detection block 112 generates congestion scores for the NGs 130. In step 306, the congestion detection block 112 compares the congestion scores for the NGs to their assigned congestion-score threshold values. In some implementations, NGs 130 may be independently assigned different network metric weight values (w1-w5) and/or different congestion-score threshold values.

The congestion scores depend on the types of application/service consumed by the set of users. Once network congestion occurs in a network, the corresponding NG performances will go down, which ultimately gets recorded in the performance analytics or telemetry data analytics. These log files can be analyzed by the network administrator to determine the levels/values of network metrics (bandwidth, latency, etc.) at the time of the network congestion. Such values can then be used to determine congestion score thresholds for the different use cases using the above-described CS equation. Note that the congestion score threshold may be different for different NGs handling different use cases.

If, in step 306, the congestion detection block 112 determines that none of the congestion scores exceed their associated threshold values, then processing returns to step 302 to await the next set of network metrics from the NGs 130. If, however, the congestion detection block 112 determines, in step 306, that one or more of the congestion scores do exceed their associated threshold values, then, in step 308, the QoS estimator 114 uses the corresponding network metrics for the congested NGs 130 to estimate the network resources (e.g., bandwidth, latency, flow-level bitrate) needed by the access networks 140 of the congested NGs 130 to handle their corresponding, current traffic loads. The QoS estimator 114 receives information like Congestion Score, current bandwidth/latency/bit-rate, etc., corresponding to a congested NG. The QoS estimator 114 also is aware of the end use case served by the NG (this information can be fetched by the AN resource manager 110). For example, if a video streaming service is served by an NG 130, the QoS estimator 114 has a reference set of Network Resources required (via the Network Administrator) to serve the use case for one user. The QoS estimator 114 now extrapolates this to the actual number of users served by the congested NG 130, and estimates the total network resources needed by the NG 130 to seamlessly serve the video streaming service.

In step 310, the QoS manager 116 uses the estimated required network resources from the QoS estimator 114 to cause network resources to be allocated to the congested NGs 130 and, if necessary and appropriate, de-allocated from other, non-congested NGs 130. In some implementations, this allocation and de-allocation are assisted by the SDNCs 120, which have a broad view of all of the NGs 130 in the SDN 100. For example, an SDNC 120 may identify network resources that can be moved from one or more nearby, non-congested NGs 130 to a congested NG 130. In this way, existing network resources in the SDN 100 are re-used without having to provision any new network resources. Following step 310, processing returns to step 302 to await the next set of network metrics from the NGs 130 to repeat the processing 300.

In some implementations, the processing 300 of FIG. 3 is performed at the gateway level, where a congestion score is generated for each network gateway 130 and compared to a corresponding, gateway-level threshold value to determine whether network resources should be re-allocated. In other implementations, the processing 300 is performed at the port level, where congestion scores are generated for different ports, such as the access port 134 and the network port 138 of each network gateway 130, and compared to corresponding, port-level threshold values to determine whether network resources should be re-allocated.

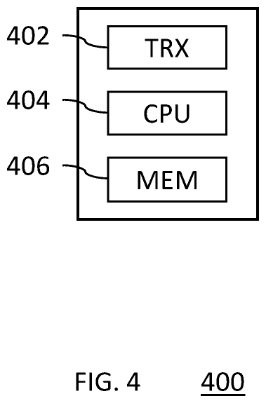

FIG. 4 is a simplified hardware block diagram of an example node 400 that can be used to implement any of the nodes 110, 120, 130 of FIG. 1. As shown in FIG. 4, the node 400 includes (i) communication hardware (e.g., wireless, wireline, and/or optical transceivers (TRX)) 402 that supports communications with other nodes, (ii) a processor (e.g., CPU microprocessor) 404 that controls the operations of the node 400, and (iii) a memory (e.g., RAM, ROM) 406 that stores code executed by the processor 404 and/or data generated and/or received by the node 400.

In certain embodiments, the present disclosure is a method for managing a first network gateway (NG) of a software-defined network (SDN). The method comprises (i) receiving different network metrics from the first NG; (ii) generating a first congestion score based on a weighted sum of the network metrics; and (iii) if the first congestion score is determined to exceed a first threshold value, then allocating one or more additional network resources for the first NG.

In at least some of the above embodiments, the first congestion score is one of two or more congestion scores generated and thresholded for two or more respective ports of the first NG.

In at least some of the above embodiments, the first congestion score is an access-port congestion score generated and thresholded for an access port of the first NG; and a second congestion score is a network-port congestion score generated and thresholded for a network port of the first NG.

In at least some of the above embodiments, the access port and the network port have different congestion-score threshold values.

In at least some of the above embodiments, the network metrics comprise two or more of user density, application bit rate, average latency, average jitter, and available bandwidth.

In at least some of the above embodiments, the network metrics comprise user density, application bit rate, average latency, average jitter, and available bandwidth.

In at least some of the above embodiments, the method further comprises receiving different network metrics from a second NG of the SDN; generating a second congestion score based on a weighted sum of the network metrics from the second NG; and, if the second congestion score is determined to exceed a second threshold value, then allocating one or more additional network resources for the second NG.

In at least some of the above embodiments, the first and second NGs correspond to different use cases, and the first threshold value for the first NG is different from the second threshold value for the second NG.

In at least some of the above embodiments, the first and second NGs correspond to different use cases, and one or more weight values used to generate the first congestion score are different from one or more corresponding weight values used to generate the second congestion score.

In at least some of the above embodiments, allocating the one or more additional network resources for the first NG involves de-allocating one or more existing network resources from one or more other NGs.

In at least some of the above embodiments, the one or more other NGs have congestion scores that do not exceed their threshold values.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for managing a first network gateway (NG) of a software-defined network (SDN), the method comprising:
receiving different network metrics from the first NG;
generating a first congestion score based on a weighted sum of the network metrics; and
if the first congestion score is determined to exceed a first threshold value, then allocating one or more additional network resources for the first NG.

2. The method of claim 1, wherein the first congestion score is one of two or more congestion scores generated and thresholded for two or more respective ports of the first NG.

3. The method of claim 2, wherein:
the first congestion score is an access-port congestion score generated and thresholded for an access port of the first NG; and
a second congestion score is a network-port congestion score generated and thresholded for a network port of the first NG.

4. The method of claim 3, wherein the access port and the network port have different congestion-score threshold values.

5. The method of claim 1, wherein the network metrics comprise two or more of user density, application bit rate, average latency, average jitter, and available bandwidth.

6. The method of claim 1, wherein the network metrics comprise user density, application bit rate, average latency, average jitter, and available bandwidth.

7. The method of claim 1, further comprising:
receiving different network metrics from a second NG of the SDN;
generating a second congestion score based on a weighted sum of the network metrics from the second NG; and
if the second congestion score is determined to exceed a second threshold value, then allocating one or more additional network resources for the second NG.

8. The method of claim 7, wherein:
the first and second NGs correspond to different use cases; and
the first threshold value for the first NG is different from the second threshold value for the second NG.

9. The method of claim 7, wherein:
the first and second NGs correspond to different use cases; and
one or more weight values used to generate the first congestion score are different from one or more corresponding weight values used to generate the second congestion score.

10. The method of claim 1, wherein allocating the one or more additional network resources for the first NG involves de-allocating one or more existing network resources from one or more other NGs.

11. The method of claim 10, wherein the one or more other NGs have congestion scores that do not exceed their threshold values.

12. An apparatus comprising:
at least one processor; and
at least one memory storing instructions that, upon being executed by the at least one processor, cause the apparatus at least to:
receive different network metrics from a first network gateway (NG) of a software-defined network (SDN);
generate a first congestion score based on a weighted sum of the network metrics; and
if the apparatus determines that the first congestion score exceeds a first threshold value, then allocate one or more additional network resources for the first NG.

13. The apparatus of claim 12, wherein the apparatus is adapted to generate and threshold the first congestion score as one of two or more congestion scores for two or more respective ports of the first NG.

14. The apparatus of claim 13, wherein:
the apparatus is adapted to generate and threshold an access-port congestion score for an access port of the first NG; and
the apparatus is adapted to generate and threshold a network-port congestion score for a network port of the first NG.

15. The apparatus of claim 14, wherein the access port and the network port have different congestion-score threshold values.

16. The apparatus of claim 12, wherein the network metrics comprise two or more of user density, application bit rate, average latency, average jitter, and available bandwidth.

17. The apparatus of claim 12, wherein the network metrics comprise user density, application bit rate, average latency, average jitter, and available bandwidth.

18. The apparatus of claim 12, wherein the apparatus is further adapted to:
receive different network metrics from a second NG of the SDN;
generate a second congestion score based on a weighted sum of the network metrics from the second NG; and
if the apparatus determines that the second congestion score exceeds a second threshold value, then allocate one or more additional network resources for the second NG.

19. The apparatus of claim 18, wherein:
the first and second NGs correspond to different use cases; and
the first threshold value for the first NG is different from the second threshold value for the second NG.

20. The apparatus of claim 18, wherein:
the first and second NGs correspond to different use cases; and
one or more weight values used to generate the first congestion score are different from one or more corresponding weight values used to generate the second congestion score.

21. The apparatus of claim 12, wherein the apparatus allocating the one or more additional network resources for the first NG involves the apparatus de-allocating one or more existing network resources from one or more other NGs.

22. The apparatus of claim 21, wherein the apparatus is adapted to determine that the one or more other NGs have congestion scores that do not exceed their threshold values.
